(19) United States
(12) Patent Application Publication
(10) Pub. No.: US 2025/0102761 A1
(43) Pub. Date: Mar. 27, 2025

(54) LENS DRIVING MECHANISM, LENS APPARATUS, AND IMAGE PICKUP APPARATUS

(71) Applicant: CANON KABUSHIKI KAISHA, Tokyo (JP)

(72) Inventor: Hiroki OSAKA, Tochigi (JP)

(21) Appl. No.: 18/825,337

(22) Filed: Sep. 5, 2024

(30) Foreign Application Priority Data
Sep. 21, 2023 (JP) 2023-156563

(51) Int. Cl. G02B 7/02; G02B 7/04

(52) U.S. Cl. CPC G02B 7/023; G02B 7/022; G02B 7/026; G02B 7/04

(57) ABSTRACT

A lens driving mechanism includes: a holding member that holds a lens and is movable in an optical axis direction; a feed screw extending in the optical axis direction; a driving unit that rotates the feed screw; a rack that comprises: a meshing portion having a first portion that meshes with the feed screw; an opposing portion having a second portion disposed opposite to the first portion with the feed screw disposed therebetween; a mounting portion connected to the holding member; and a connecting portion having an elasticity and connecting the mounting portion and the opposing portion; a first elastic member biasing the meshing portion against the feed screw with a first force; and a second elastic member biasing a first contact portion of the meshing portion and a second contact portion of the opposing portion to press against each other with a second force.

### BACKGROUND OF THE INVENTION

### Field of the Invention

The present invention relates to a lens driving mechanism, a lens apparatus, and an image pickup apparatus.

### Description of the Related Art

Along with the demand for miniaturization of optical devices such as digital still cameras and digital video cameras, miniaturization of lens barrels mounted thereon is also demanded. In addition, power saving of the lens barrel is also required in order to reduce the size of the battery and to prolong the photographing time.

In addition, in these optical apparatuses, there are many products that employ a movement mechanism that uses a torsion coil spring for biasing the rack to a feed screw connected to a shaft of a motor in order to move the lens holding frame that holds the lens in the optical axis direction.

Japanese Patent Application Laid-Open No. 2008-158069 discloses a configuration in which, in a lens barrel, a motor and a rack are used to move a lens holding frame in an optical axis direction, teeth that sandwich a feed screw are provided to face main teeth for the purpose of preventing vibration and noise during driving, and the teeth are connected to a rack main body by a connecting portion.

Japanese Patent Application Laid-Open No. 2014-194486 discloses a configuration in which a rack is divided into two parts so as to reduce a biasing force of the rack with respect to a feed screw in order to reduce a load torque of a motor.

In a rack having a structure in which the feed screw is sandwiched between the main teeth and the sandwiching teeth, the main teeth and the sandwiching teeth are disengaged from each other with respect to the feed screw due to an impact such as a drop, and the position of the rack is shifted, thereby causing disturbance or blurring of the picked up image. In order to prevent tooth skipping, when a strong biasing force is applied between the rack and the feed screw as disclosed in Japanese Patent Application Laid-Open No. 2008-158069, a load of the motor is increased due to an increase in frictional force between the rack and the feed screw, power saving is hindered, and an increase in size of the lens barrel is caused.

On the other hand, in a rack having a structure in which only the main tooth biased is engaged with the feed screw in a normal state in which an impact is not applied, the opposing tooth disposed on the opposite side of the main tooth with respect to the axis of the feed screw is engaged with the thread of the feed screw when an impact is applied, thereby preventing the rack from being displaced in the axial direction of the feed screw. However, in the case where only the main tooth comes into contact with the feed screw, in order to stabilize the movement of the rack, it is necessary to increase the force for biasing the main tooth to the feed screw, which increases the load of the motor, hinders power saving, and leads to an increase in the size of the lens barrel.

### SUMMARY OF THE INVENTION

The present invention provides a lens driving mechanism that is compact and can be driven stably against impact.

In order to achieve the above object, a lens driving mechanism according to the present invention includes: a holding member that holds a lens and is movable in an optical axis direction; a feed screw extending in the optical axis direction; a driving unit that rotates the feed screw; a rack that comprises: a meshing portion having a first portion that meshes with the feed screw; an opposing portion having a second portion disposed opposite to the first portion with the feed screw disposed therebetween; a mounting portion connected to the holding member; and a connecting portion having an elasticity and connecting the mounting portion and the opposing portion; a first elastic member biasing the meshing portion against the feed screw with a first force; and a second elastic member biasing a first contact portion of the meshing portion and a second contact portion of the opposing portion to press against each other with a second force.

Further features of the present invention will become apparent from the following description of exemplary embodiments with reference to the attached drawings.

### BRIEF DESCRIPTION OF THE DRAWINGS

FIG. 1 is a connection configuration diagram of a lens barrel and a camera apparatus according to the present invention.

FIG. 2A is a configuration diagram of a focus driving unit and a focus moving lens unit.

FIG. 2B is a configuration diagram of a focus driving unit and a focus moving lens unit.

FIG. 3A is an enlarged plan view showing a molded state of the rack.

FIG. 3B is an enlarged plan view showing a use state of the rack.

FIG. 4 is a side view showing a restricting shape of the rack in an optical axis direction.

FIG. 5A is an arrow view showing the restricting shape of the opening and closing direction of the rack.

FIG. 5B is an arrow view showing the restricting shape of the opening and closing direction of the rack.

FIG. 5C is an arrow view showing the restricting shape of the opening and closing direction of the rack.

FIG. 6A is an enlarged plan view of the feed screw and rack engagement.

FIG. 6B is an enlarged plan view of the feed screw and rack engagement.

FIG. 7A is a side view for explaining an opening operation of the rack.

FIG. 7B is a side view for explaining the opening operation of the rack.

FIG. 7C is a side view for explaining the opening operation of the rack.

### DESCRIPTION OF THE EMBODIMENTS

Hereinafter, preferred embodiments of the present invention will be described in detail with reference to the accompanying drawings.

### EMBODIMENTS

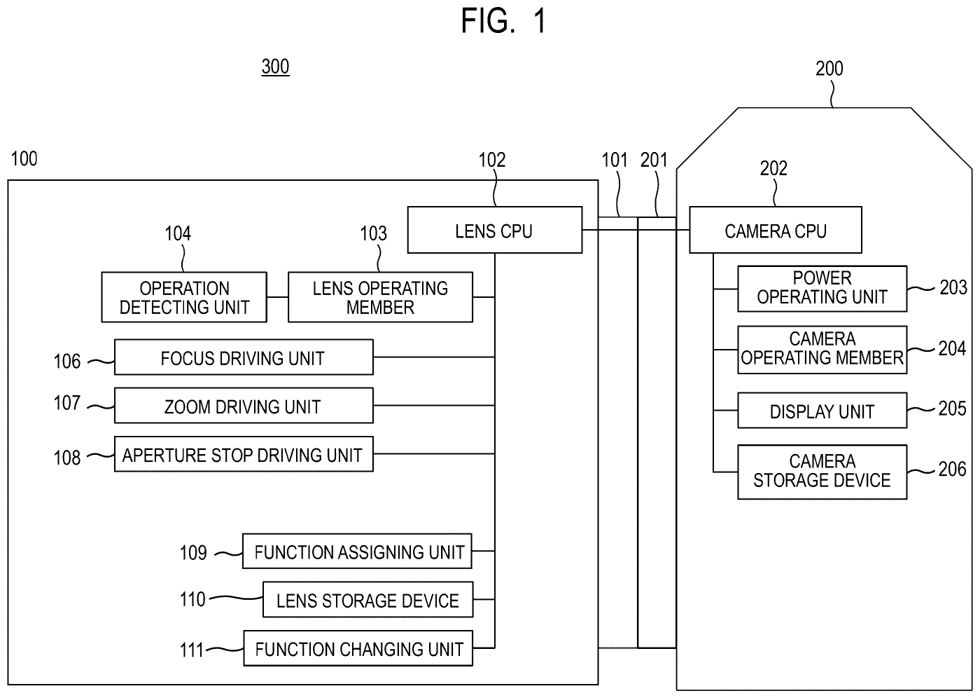

Hereinafter, a lens driving mechanism according to an embodiment of the present invention will be described with reference to FIGS. 1 to 7C. In the present embodiment, an interchangeable lens is described as an example, but the present invention can be applicable to a lens-integrated image pickup apparatus. In addition, although a plurality of features is described in the present embodiment, all of the plurality of features is not necessarily essential for the embodiment, and the plurality of the features may be arbitrarily combined. In addition, in the accompanying drawings, in order to facilitate understanding of the apparatus according to the present embodiment, the same or similar components are denoted by the same reference numerals, and redundant description thereof will be omitted.

FIG. 1 is a connection configuration diagram of an image pickup apparatus 300 including a lens apparatus 100 and a camera apparatus 200 according to the present invention.

The lens apparatus 100 includes a lens mount 101, a lens CPU 102, and a lens operation member 103. The lens mount 101 mechanically connects the lens apparatus 100 to the camera apparatus 200. The lens CPU 102 controls the lens apparatus 100 and controls the communication with the camera apparatus 200 and functions implemented in the camera apparatus 200. The lens operation member 103 performs operations, selection, determination, and controlling in various functions of the lens apparatus 100.

In addition, the lens apparatus 100 includes an operation detecting unit 104 that detects an operation direction and an operation amount of a function ring that is a rotation operation member (not illustrated). The operation detecting unit 104 is, for example, a photo interrupter (not shown), and detects the operation direction and the operation amount of the function ring by detecting light reception and light shielding according to a rectangular wave shape (not shown) provided in the inner diameter portion of the function ring.

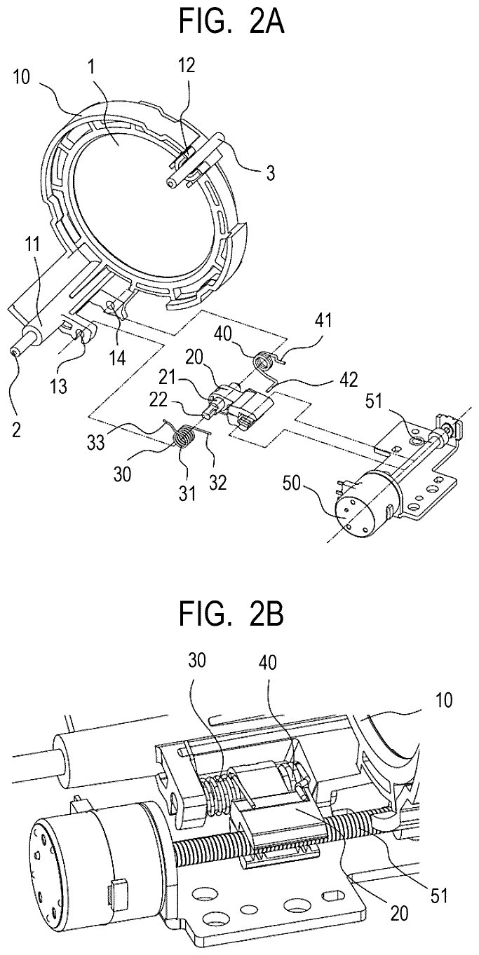

The lens apparatus 100 includes a focus driving unit 106, a zoom driving unit 107, and an aperture driving unit 108. The focus driving unit 106 is connected to the first lens unit 1 as a focus lens unit shown in FIGS. 2A and 2B and changes the in-focus distance of the lens apparatus 100 by moving the focus lens unit in the optical axis direction in accordance with the operation direction and the operation amount at the time of operation of a focus ring (not shown).

The zoom driving unit 107 is connected to a zoom lens unit (not shown) and changes the focal length of the lens apparatus 100 by moving the zoom lens unit in the optical axis direction in accordance with an operation direction and an operation amount at the time of operation of a zoom ring (not shown), thereby changing the angle of view. The aperture driving unit 108 is connected to an aperture stop (not shown), drives the aperture stop according to an operation of the camera apparatus 200, and adjusts the amount of light incident on an image pickup element (not shown) of the camera apparatus 200.

In addition, the lens apparatus 100 includes a function assigning unit 109, a lens storage device 110, and a function change unit 111 related to the function ring. The function assigning unit 109 assigns the various functions described above to the function ring. The lens storage device 110 is a storage device that stores priorities of function assignments set in advance for automatically connecting functions to the function ring. The function changing unit 111 is a unit for changing the function assigned to the function ring to another function.

Next, a configuration of the camera apparatus 200 will be described.

The camera apparatus 200 includes a camera mount 201, a camera CPU 202, a power operating unit 203, a camera operation member 204, a display unit 205, and a camera storage device 206. The camera mount 201 is mechanically connected to the lens mount 101 of the lens apparatus 100. The camera CPU 202 controls and communicates with the camera apparatus 200 and controls and communicates with the lens apparatus 100. A power source operating unit 203 operates ON and OFF of a power source for energizing the camera apparatus 200. The camera operation member 204 performs operations such as operation of various functions of the camera apparatus 200, selection, determination and cancellation of various functions, and a shutter release operation. The display unit 205 displays various settings of the camera apparatus 200 and a captured image. The camera storage device 206 stores various settings and captured images of the camera device 200.

FIGS. 2A and 2B are configuration diagrams illustrating a schematic configuration of a focus unit according to the present exemplary embodiment.

The focus motor 50, which is the focus driving unit 106, is fixed to a fixed barrel (not shown) of the lens apparatus 100. A rack 20 connected to a holding member 10 that supports the first lens unit (focus lens unit) 1 is engaged with a feed screw 51 that is coaxially fixed to the rotation shaft of the focus motor 50 and extends in the optical axis direction. When the focus motor 50 rotates, the driving force of the focus motor 50 is transmitted to the holding member 10 via the rack 20, and the first lens unit 1 is moved in the optical axis direction.

The first lens unit 1 is a focus lens unit and is supported by a holding member 10. The holding member 10 is provided with support portions 11 and 12 that are slidably supported with respect to the two guide bars 2 and 3, and thus the image pickup optical system is movable in the optical axis direction.

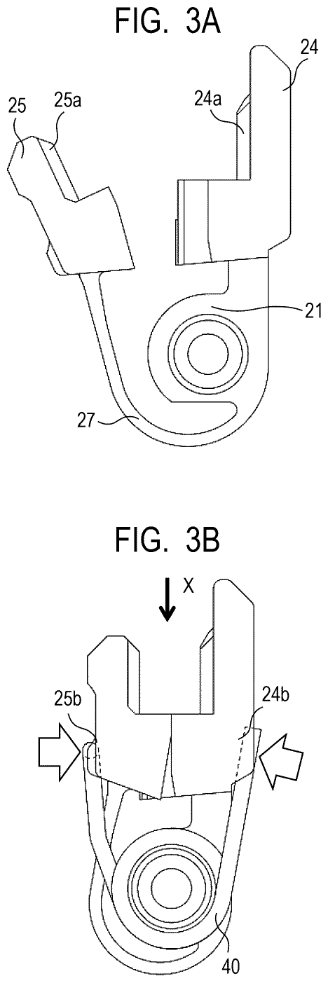

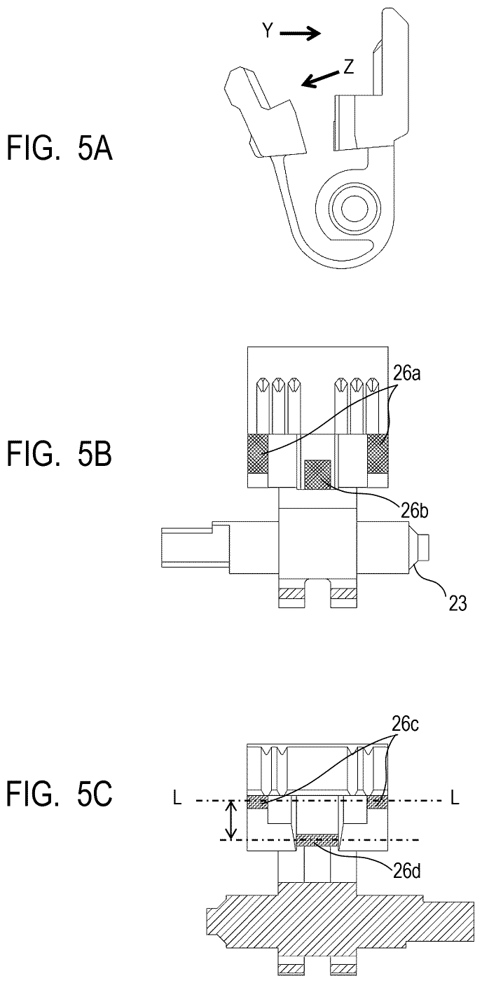

The rack 20 includes a mounting portion 21, a meshing portion 24 shown in FIGS. 3A and 3B, and an opposing portion 25. The mounting portion 21 is a structure for holding the rack 20 by the holding member 10 and includes a rotation shaft 22 and a tapered portion 23 shown in FIGS. 5A, 5B, and 5C. The rack 20 is made of, for example, POM resin (polyacetal resin), PC (polycarbonate), or the like.

Between the holding member 10 and the guide bars 2 and 3, between the holding member 10 and the rack 20, and between the rack 20 and the feed screw 51, they are engaged with each other with play. Backlash caused by the play of engagement such as fitting or meshing between them is biased by a torsion coil spring 30. The torsion coil spring (first elastic member) 30 includes a coil portion 31 and arm portions 32 and 33.

A clamping spring (second elastic member) 40 is attached to the rack 20, and the clamping spring 40 applies a biasing force so that the main teeth (first portion, first gear teeth) 24a and the opposing teeth (second portion, second gear teeth) 25a clamp the feed screw 51. The clamping spring 40 has arm portions 41 and 42.

The focus motor 50 is a driving unit (actuator) that moves the first lens unit 1, which is a focus lens unit, in the optical axis direction to perform a focusing operation. The feed screw 51 rotated by the focus motor 50 is engaged with a rack 20 installed in a holding member 10 that is guided and supported so as to be movable in the optical axis direction. When the focus motor 50 rotates, the holding member 10 moves in the optical axis direction. The feed screw 51 is coaxial with the rotation axis of the focus motor 50 and is disposed parallel to the optical axis. The feed screw 51 is made of, for example, stainless steel, steel and the like.

The coil portion 31 of the torsion coil spring 30 is held by the mounting portion 21 of the rack 20 and is rotatably supported by a rack holding portion configured by the first bearing portion 13 and the second bearing portion 14 of the holding member 10. The rotation shaft 22 is inserted into the first bearing portion 13, and the tapered portion 23 is inserted into the second bearing portion 14, whereby the rack 20 is supported so as to be immovable with respect to the holding member 10 in the optical axis direction and rotatable about the axes of the first bearing portion 13 and the second bearing portion 14. The rack 20 is biased in the rack holding portion in a direction in which the tapered portion 23 is pressed against the second bearing portion 14 by the torsion coil spring 30, so that the rack 20 is positioned in the optical axis direction with respect to the rack holding portion.

FIGS. 3A and 3B are enlarged plan views of the rack 20 and the clamping spring 40. FIG. 3A shows a molded state of the rack 20, and the opposing portion 25 and the mounting portion 21 are connected to each other by an elastically deformable connecting portion 27. In addition, FIG. 3A shows a state in which the shape of the connecting portion 27 molded at the time of manufacturing is in a state in which the elastic force of the connecting portion 27 is not applied in any direction (also referred to as a natural state of the connecting portion 27), and in a state in which the meshing portion 24 and the opposing portion 25 are separated from each other. The connecting portion 27 extends from the meshing portion 24 side of the mounting portion 21 to the opposing portion 25 so as to surround 25% or more of the outer circumference of the mounting portion 21 about the axial direction of the feed screw 51. By configuring the connecting portion 27 in this manner, it is possible to configure the connecting portion 27 to be long with a small space, and by setting the deformable region of the connecting portion 27 to be long, it is possible to disperse stress applied to the connecting portion 27 in a wide region when the meshing portion 24 and the opposing portion 25 are closed so as to approach each other.

As will be described later, the rack 20 is provided with a protruding portion (convex portion) 28 toward the opposing portion 25 on the mounting portion 21 side of the meshing portion 24 and is provided with a recessed portion 29 facing the meshing portion 24 side on the mounting portion 21 side of the opposing portion 25. The protruding portion 28 and the recessed portion 29 are facing each other and are fitted to each other. For example, when the rack 20 formed of a resin is molded by a mold, it is necessary to maintain the strength of the mold corresponding to the closest portion in a state where the closest portion between the protruding portion 28 and the recessed portion 29 is separated to some extent and to enable stable manufacturing. Therefore, it is necessary to form the meshing portion 24 and the opposing portion 25 in a state in which the meshing portion 24 and the opposing portion 25 are largely opened, and to use them in a state in which the meshing portion 24 and the opposing portion 25 are close to each other up to a predetermined interval at the time of use. On the other hand, by adopting a configuration in which the deformable region of the connecting portion 27 is long as described above, it is possible to form the meshing portion 24 and the opposing portion 25 in a state in which they are largely opened.

A main teeth 24a is formed on the opposing portion 25 side of the meshing portion 24 of the rack 20, and the main teeth 24a engage with the threads of the feed screw 51 and receive the driving force of the focus motor 50 from the feed screw 51. A surface 24b of the meshing portion 24 opposite to the opposing portion 25 functions as a locking surface on which the arm portion 32 of the torsion coil spring 30 and the arm portion 41 of the clamping spring 40 are locked.

The opposing teeth 25a are formed on the meshing portion 24 side of the opposing portion 25, and the opposing teeth 25a are configured to be engageable with the feed screw 51. A surface 25b of the opposing portion 25 opposite to the meshing portion 24 functions as a locking surface for locking the arm portion 42 of the clamping spring 40. Note that, in the present embodiment, the opposing teeth 25a are formed, but in a state where the main teeth 24a are engaged with the feed screw 51 shown in FIG. 3B, a flat surface configured to have a constant distance from the feed screw 51 may be used. By setting the flat surface to face the main teeth 24a, it is possible to prevent the main teeth 24a and the feed screw 51 from being separated from each other by a predetermined distance or more.

The main teeth 24a are pressed against the feed screw 51 with a first biasing force (first force) by the biasing force of the torsion coil spring 30. The main teeth 24a and the opposing teeth 25a have a positional relationship in which main contact surfaces (first contact portions) 26a and 26b and sub contact surfaces (second contact portions) 26c and 26d, which will be described later with reference to FIGS. 5A, 5B, and 5C, abut against each other by the second biasing force (second force) of the clamping spring 40 to clamp the feed screw 51. However, in a normal use state, the opposing tooth 25a and the feed screw 51 do not contact each other and have play. Therefore, the driving force generated by the rotation of the feed screw 51 is transmitted to the holding member 10 via the main teeth 24a, whereby the holding member 10 is moved in the optical axis direction. The first biasing force of the torsion coil spring 30 is smaller than the second biasing force of the clamping spring 40. More specifically, the first biasing force of the torsion coil spring 30 is smaller than the biasing force obtained by subtracting the reaction force (third force) generated at the connecting portion 27 from the second biasing force of the clamping spring 40.

FIG. 3B shows a use state in which the clamping spring 40 is incorporated into the rack 20. The opposing portion 25 is formed so as to be more distant from the meshing portion 24 than in the use state. By incorporating the clamping spring 40 into the rack 20, the second biasing force acts in the direction in which the meshing portion 24 and the opposing portion 25 approach each other, the opposing portion 25 moves to the position in the use state with respect to the meshing portion 24, and the meshing portion 24 and the opposing portion 25 close so as to approach each other to the maximum extent.

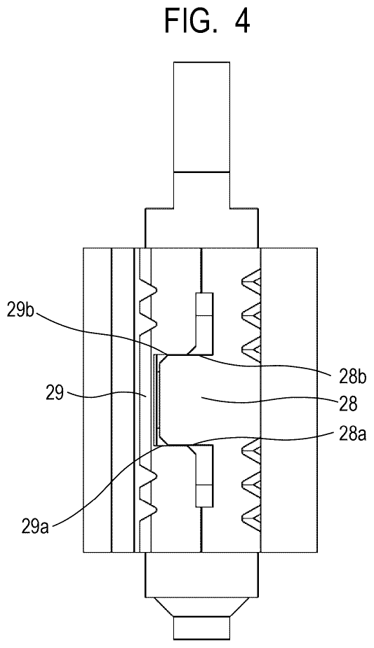

FIG. 4 is a view seen from the direction of the arrow X shown in FIG. 3B. A protruding portion 28 is provided toward the opposing portion 25 on the mounting portion 21 side of the meshing portion 24, and a recessed portion 29 is provided on the mounting portion 21 side of the opposing portion 25 so as to face the meshing portion 24. In other words, a protruding portion 28 protruding in the direction of the feed screw 51 is provided on the meshing portion 24 side, and a recessed portion 29 corresponding to the protruding portion 28 is provided on the opposing portion 25 side. The protruding portion 28 has a surface 28a and a surface 28b orthogonal to the axial direction of the feed screw 51. The recessed portion 29 has a surface 29a facing the surface 28a and a surface 29b facing the surface 28b. When a force that causes a shift between the main teeth 24a and the opposing teeth 25a in the axial direction of the feed screw 51 is generated, the surface 28a and the surface 29a or the surface 28b and the surface 29b abut against each other, and relative movement (deviation) between the main teeth 24a and the opposing teeth 25a with respect to each other in the axial direction of the feed screw 51 is suppressed.

In the embodiment, the protruding portion 28 is provided in the meshing portion 24, and the recessed portion 29 is provided in the opposing portion 25, but the present invention is not limited thereto. The protruding portion 28 may be provided on one of the meshing portion 24 and the opposing portion 25, and the recessed portion 29 may be provided on the other of the meshing portion 24 and the opposing portion 25.

FIGS. 5A, 5B, and 5C are diagrams illustrating shapes related to restriction of the opening and closing direction of the rack 20. FIG. 5A is a view of the rack 20 viewed from the axial direction of the rotation shaft 22, FIG. 5B is a view of the meshing portion 24 viewed from the direction of the arrow Y in FIG. 5A, and FIG. 5C is a view of the opposing portion 25 viewed from the direction of the arrow Z in FIG. 5A. On the meshing portion 24 side, there are three abutting surfaces that abut against the opposing portion 25 side. The two main contact surfaces (first contact surfaces) 26a are provided apart from each other in the axial direction of the feed screw 51 and a main contact surface (second contact surface) 26b is provided apart from the two main contact surfaces 26a in a direction perpendicular to the axial direction of the feed screw 51. The main contact surface 26b is provided between the two main contact surfaces 26a in the axial direction of the feed screw 51.

There are three contact surfaces on the opposing portion 25 side, and two sub-contact surfaces (third contact surfaces) 26c are provided at positions corresponding to the main contact surfaces 26a. A sub contact surface (fourth contact surface) 26d is provided at a position corresponding to the main contact surface 26b. The corresponding main contact surfaces 26a and 26b and the corresponding sub contact surfaces 26c and 26d abut against each other, so that the distance between the meshing portion 24 and the opposing portion 25 is regulated so as not to approach each other more than a predetermined distance. In addition, since each of them comes into contact at three portions, an angle of the opposing portion 25 with respect to the meshing portion 24 is stabilized. As a result, since the relative angle between the main teeth 24a and the opposing teeth 25a can be kept constant, the interval between the feed screw 51 and the opposing teeth 25a in a normal use state can be stably maintained.

In the present embodiment, two of the three contact surfaces of the main contact surfaces 26a and 26b and the sub contact surfaces 26c and 26d are provided on the same line in the axial direction of the feed screw 51, but the present invention is not limited thereto. In the present embodiment, the sub contact surface is set to be smaller than the main contact surface, but the main contact surface may be set to be smaller than the sub contact surface. In the present embodiment, the main contact surface 26b is not flush with the main contact surface 26a when viewed from the direction perpendicular to the axis, but may be flush with the main contact surface 26a.

As shown in FIGS. 2A and 3B, the arm portion 42 of clamping spring 40 includes a parallel portion configured parallel to the axial direction of the feed screw 51. The parallel portion is set so as to bias the opposing portion 25 toward the meshing portion 24 between a straight line L-L passing through the center of the sub-contact surface 26c and parallel to the axial direction and the center of the sub-contact surface 26d in a direction perpendicular to the axial direction of the feed screw 51 and parallel to the sub-contact surfaces 26c and 26d. In the axial direction, the clamping spring 40 is set so as to press and bias a portion between the two sub-contact surfaces 26c. Specifically, it is preferable to bias the periphery of a point that corresponds to the middle between the two straight lines in the direction perpendicular to the axial direction and the middle between the two sub-contact surfaces 26c in the axial direction. Alternatively, by biasing between the contact surfaces, a force is uniformly applied to each contact surface, and even when an impact is applied to the device, the relative position of the opposing portion 25 with respect to the meshing portion 24 can be stably maintained.

Although not illustrated in the present embodiment, a contact surface may be provided to prevent the relative position between the meshing portion 24 and the opposing portion 25 in the direction parallel to the main teeth 24a (the direction of the arrow X in FIGS. 3A and 3B).

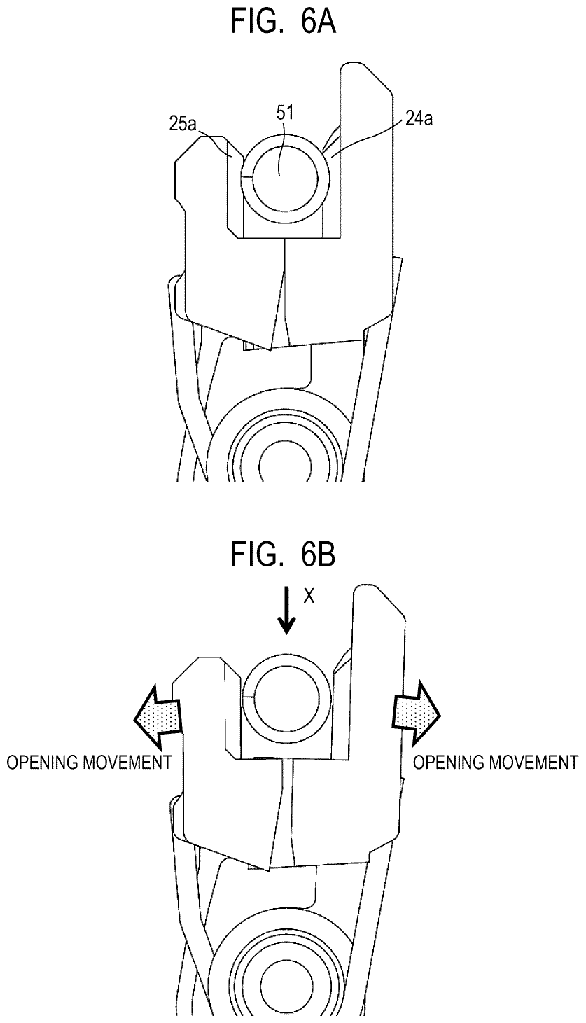

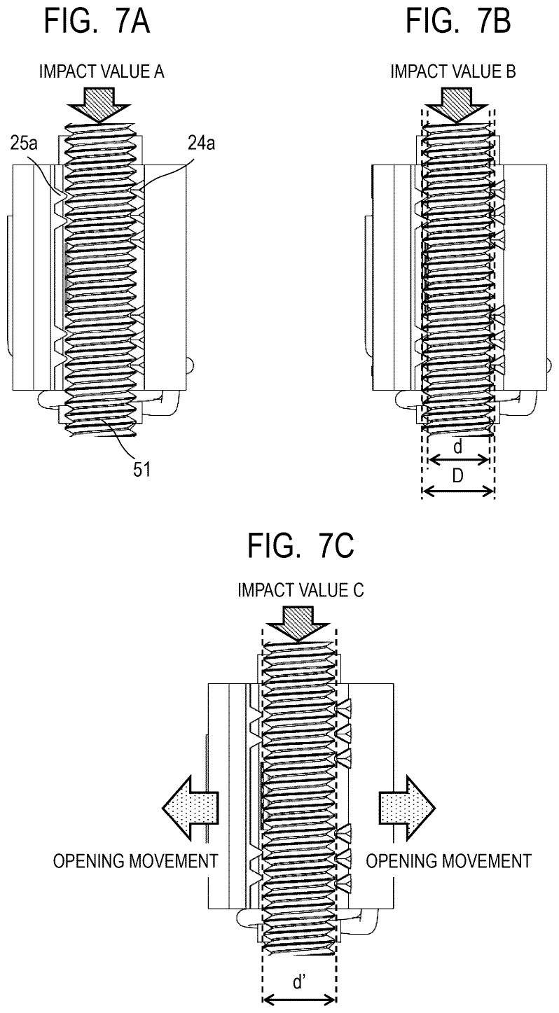

FIGS. 6A and 6B are enlarged plan views of the engagement portion between the feed screw 51 and the rack 20. FIG. 6A shows a normal state in which an opening operation to be described later is not performed, and FIG. 6B shows a state in which the opening operation is performed. FIGS. 7A, 7B, and 7C are enlarged cross-sectional views showing the engagement of the main teeth 24a, the opposing teeth 25a, and the feed screw 51, and correspond to views viewed in the direction of the arrow X shown in FIG. 6B.

First, in a normal state, a plane passing through the central axis of the feed screw 51 and the contact position between the main teeth 24a and the feed screw 51 is considered. Note that the normal state is a state in which the main teeth 24a are engaged with the feed screw 51 by the biasing force of the torsion coil spring 30, and a state in which no impact is applied to the lens driving mechanism, that is, a state in which no acceleration is applied between the feed screw 51 and the rack 20. In the normal state, the main contact surfaces 26a and 26b and the sub contact surfaces 26c and 26d abut against each other, and the distance between the closest portions of the main teeth 24a and the opposing teeth 25a is smaller than the outer diameter D of the feed screw 51. In addition, in the normal state, the main abutment surfaces 26a and 26b and the sub abutment surfaces 26c and 26d abut against each other, and the opposing teeth 25a and the feed screw 51 do not contact each other and have play.

FIGS. 7A, 7B, and 7C are enlarged cross-sectional views when various impacts are applied to the feed screw 51 with respect to the main teeth 24a and the opposing teeth 25a.

FIG. 7A shows a state in which an impact value A is applied to the feed screw 51 in the axial direction. At this time, since the main teeth 24a are engaged with the thread of the feed screw 51, the rack 20 does not shift in the axial direction of the feed screw 51.

FIG. 7B shows a state in which an impact value B larger than the impact value A is applied to the feed screw 51 in the axial direction, and the main tooth 24a rises along the thread of the feed screw 51. At this time, since the meshing portion 24 and the opposing portion 25 are biased by the clamping spring 40, the interval d defined by the interval between the apexes (closest positions) of the threads of the main teeth 24a and the opposing teeth 25a is maintained, and thus the opposing portion 25 approaches the threads of the feed screw 51. The distance d between the main teeth 24a and the opposing teeth 25a is set to be smaller than the outer diameter D of the feed screw 51. Therefore, since both the main teeth 24a and the opposing tooth 25a are engaged with the thread of the feed screw 51, the main teeth 24a and the opposing tooth 25a do not go beyond the thread of the feed screw 51 so that the rack 20 does not move further in the axial direction of the feed screw 51.

FIGS. 6B and 7C show a state in which an impact value C larger than the impact value B is applied to the feed screw 51 in the axial direction. A force in a direction away from each other is applied to the main teeth 24a and the opposing tooth 25a by a reaction force from the thread of the feed screw 51. When this force exceeds the biasing force obtained by subtracting the reaction force generated at the connecting portion 27 from the biasing force of the clamping spring 40, the opening operation of the meshing portion 24 and the opposing portion 25 is generated against the elastic force of the clamping spring 40. As a result, the distance between the main teeth 24a and the opposing teeth 25a is increased to d′. Here, the magnitude relationship among D, d, and d′ satisfies d<D≤d′. Therefore, tooth jumping in which the rack teeth move in the axial direction over the thread of the feed screw 51 is permitted. Accordingly, it is possible to prevent damage such as chipping or scraping of the rack teeth or the feed screws due to a large shearing force applied to the tooth tips of the main teeth 24a and the opposing teeth 25a. If such chipping or scraping occurs, the operation becomes unstable in the subsequent product operation, which causes operation failure. In the present embodiment, the impact value C at which the opening operation of the rack 20 starts to occur can be arbitrarily set by adjusting the biasing force of the clamping spring 40.

The rack and the drive mechanism using the same according to the present embodiment can also be applied to a lens unit having a mechanism that moves in the optical axis direction such as the zoom drive unit 107. Further, in the present embodiment, the optical device having the rack 20 is an image pickup apparatus such as a lens-integrated digital still camera, but may be a lens apparatus detachably attached to the image pickup apparatus.

In the embodiment, in the rack 20, the opposing portion 25 is connected to the mounting portion 21 by the connecting portion 27, and the meshing portion 24, the opposing portion 25, the connecting portion 27, and the mounting portion 21 are configured as an integral element, but the present invention is not limited thereto. The opposing portion 25 may be configured as a separate element without being connected by the connecting portion 27. In this case, a configuration for stabilizing the position of the opposing portion 25 with respect to the meshing portion 24 may be added. However, also in such configuration, it is possible to enjoy the effect of the present invention of suppressing damage such as chipping or scraping of the feed screw 51, the main teeth 24a, and the opposing teeth 25a even when an impact force is applied while reducing the drive load without departing from the gist of the present invention.

It is possible to provide an image pickup apparatus that enjoys the effects of the present invention through an image pickup apparatus that includes a lens apparatus having a lens driving mechanism according to the present invention and an image pickup element that receives an image formed by the lens apparatus.

Although the preferred embodiments of the present invention have been described above, the present invention is not limited to the embodiments, and various modifications and changes can be made within the scope of the gist of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-156563, filed Sep. 21, 2023, which is hereby incorporated by reference herein in its entirety.

1. A lens driving mechanism, comprising:
a holding member that holds a lens and is movable in an optical axis direction;
a feed screw extending in the optical axis direction;
a driving unit that rotates the feed screw;
a rack that comprises: a meshing portion having a first portion that meshes with the feed screw; an opposing portion having a second portion disposed opposite to the first portion with the feed screw disposed therebetween; a mounting portion connected to the holding member;
and a connecting portion having an elasticity and connecting the mounting portion and the opposing portion;
a first elastic member biasing the meshing portion against the feed screw with a first force; and
a second elastic member biasing a first contact portion of the meshing portion and a second contact portion of the opposing portion to press against each other with a second force.

2. The lens driving mechanism according to claim 1, wherein in a state in which the first contact portion and the second contact portion are in contact with each other, a distance between portions of the first portion and the second portion closest to each other is smaller than an outer diameter of the feed screw.

3. The lens driving mechanism according to claim 1, wherein in a state where the first contact portion and the second contact portion are in contact with each other, there is a play between the second portion and the feed screw.

4. The lens driving mechanism according to claim 1, wherein the first force is less than the second force.

5. The lens driving mechanism according to claim 1, wherein when a force for elastically deforming the connecting portion required to bring the first contact portion and the second contact portion into contact with each other in a state where the second force is not applied is a third force, in a state where the first contact portion and the second contact portion are in contact with each other by the second elastic member, the first force is smaller than a force obtained by subtracting the third force from the second force.

6. The lens driving mechanism according to claim 1,
wherein one of the meshing portion and the opposing portion has a convex portion,
wherein in a state where the first contact portion and the second contact portion are in contact with each other, the other of the meshing portion and the opposing portion has a concave portion that engages with the convex portion,
wherein when the first contact portion and the second contact portion are in contact with each other, the convex portion and the concave portion are engaged with each other, thereby suppressing a relative movement of the meshing portion and the opposing portion in the axial direction of the feed screw.

7. The lens driving mechanism according to claim 1, wherein the first portion has first gear teeth that mesh with the feed screw.

8. The lens driving mechanism according to claim 1, wherein the second portion has second gear teeth that mesh with the feed screw.

9. The lens driving mechanism according to claim 1, wherein the second portion has a surface parallel to the axial direction of the feed screw.

10. The lens driving mechanism according to claim 1,
wherein the first contact portion is constituted by three contact surfaces, and includes two contact surfaces disposed apart from each other in an axial direction of the feed screw and one contact surface disposed apart from the two contact surfaces in a direction perpendicular to the axial direction and parallel to the two contact surfaces,
wherein the second contact portion includes three contact surfaces that contact the two contact surfaces and the one contact surface included in the first contact portion.

11. The lens driving mechanism according to claim 1,
wherein the first contact portion is constituted by three contact surfaces, and includes two first contact surfaces provided apart from each other in an axial direction of the feed screw, and a second contact surface provided apart from the two first contact surfaces in a direction perpendicular to the axial direction and parallel to the two first contact surfaces and in a direction perpendicular to the two first contact surfaces, and
wherein the second contact portion includes two third contact surfaces that contact the two first contact surfaces and a fourth contact surface that contacts the second contact surface.

12. The lens driving mechanism according to claim 11, wherein the second elastic member has an arm portion that biases the opposing portion toward the meshing portion between a straight line passing through centers of the two third contact surfaces and a center of the fourth contact surface in a direction perpendicular to the axial direction of the feed screw and parallel to the two third contact surfaces.

13. The lens driving mechanism according to claim 5, wherein the connecting portion connects the mounting portion and the opposing portion so as to surround 25% or more of an outer circumference of the mounting portion about an axial direction of the feed screw.

14. A lens apparatus comprising a lens driving mechanism,
wherein the lens driving mechanism comprises:
a holding member that holds a lens and is movable in an optical axis direction;
a feed screw extending in the optical axis direction;
a driving unit that rotates the feed screw;
a rack that comprises: a meshing portion having a first portion that meshes with the feed screw; an opposing portion having a second portion disposed opposite to the first portion with the feed screw disposed therebetween; a mounting portion connected to the holding member;
and a connecting portion having an elasticity and connecting the mounting portion and the opposing portion;
a first elastic member biasing the meshing portion against the feed screw with a first force; and
a second elastic member biasing a first contact portion of the meshing portion and a second contact portion of the opposing portion to press against each other with a second force.

15. An image pickup apparatus comprising a lens apparatus and an image pickup element receiving an image formed by the lens apparatus,
wherein the lens driving mechanism comprises:
a holding member that holds a lens and is movable in an optical axis direction;
a feed screw extending in the optical axis direction;
a driving unit that rotates the feed screw;
a rack that comprises: a meshing portion having a first portion that meshes with the feed screw; an opposing portion having a second portion disposed opposite to the first portion with the feed screw disposed therebetween; a mounting portion connected to the holding member; and a connecting portion having an elasticity and connecting the mounting portion and the opposing portion;
a first elastic member biasing the meshing portion against the feed screw with a first force; and
a second elastic member biasing a first contact portion of the meshing portion and a second contact portion of the opposing portion to press against each other with a second force.
